(19) United States
(12) Patent Application Publication
(10) Pub. No.: US 2007/0296341 A1
(43) Pub. Date: Dec. 27, 2007

(54) COLD CATHODE FLUORESCENT FLAT LAMP

(76) Inventors: Yu-Heng Hsieh, Taipei City (TW); Chu-Chi Ting, Hualien County (TW); Shen-Jiang Jeng, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,099

(22) Filed: Jun. 22, 2006

(51) Int. Cl. H01J 61/35; H01J 1/62

(52) U.S. Cl. 313/635; 313/493

(57) ABSTRACT

A cold cathode fluorescence flat lamp includes first substrate, second substrate, multiple spacers, multiple first electrodes, blue light fluorescent layer, and discharge gas. The first substrate has a first surface and the second substrate has a second surface. The second surface is opposite to the first surface. The first electrodes are disposed on the first surface of the first substrate. The blue light fluorescent layer is disposed on the second surface of the second substrate. The spacers connected with the edges of the first substrate and the second substrate for forming a chamber between the first substrate and the second substrate. The discharge gas distributes in the chamber. The first electrodes are disposed on the first surface of the first substrate and the blue light fluorescent layer is disposed on the second surface of the second substrate for being away from the plasma formed by the discharge gas.

### BACKGROUND OF THE INVENTION

1. Field of Invention

The present invention relates to a cold cathode fluorescent lamp. More particularly, the present invention relates to a cold cathode fluorescent flat lamp for lowering the decaying rate of intensity of the blue light.

2. Description of Related Art

Along with the rapid development of industries, various digital tools such as mobile phones, digital still cameras, notebook computers, desktop computers for example, are offered with much more convenience, more functions and greater appearance. The display screens of these electronic products play an indispensable role as the communication interface between users and machinery, and they bring the users with ease in using those products. In recently years, the liquid crystal display (LCD) panels are widely applied in most display screens of mobile phones, digital still cameras, notebook computers, desktop computers, etc. Yet, since the LCD panel itself is not an illuminant, it's required that a backlight module disposed under the LCD panel as a light source.

The prior art backlight module includes light emitting diode (LED) backlight modules, cold cathode fluorescent lamp backlight modules (CCFL), cold cathode fluorescent flat lamp (CCFFL), etc. FIG. 1 schematically shows the structure of a cold cathode fluorescent flat lamp in the prior art. Referring to FIG. 1, the conventional cold cathode fluorescent flat lamp 100 comprises a lower substrate 112, an upper substrate 114, multiple spacers 116, multiple sets of electrode pairs 120, a dielectric layer 130, a fluorescent material layer 140, and a discharge gas 150. The spacers 116 are disposed on the edge between the lower substrate 112 and the upper substrate 114 and between the lower substrate 112 and upper substrate 114 as well. The electrode pairs 120 are disposed on the lower substrate 112, and the dielectric layer 130 covers the electrode pairs 120. Further, a fluorescent material layer 140 including fluorescent materials of the red, green and blue lights is disposed between the electrode pairs 120. The discharge gas 150 is disposed in the space surrounded by the upper substrate 114, lower substrate 112 and the spacers 116.

The driving method of the cold cathode fluorescent flat lamp 100 is to apply a driving voltage on the electrodes 120 such that the discharge gas 150 is ionized into plasma. After that, the electrons at excited state in each ion and molecules at metastable state (e.g. Xe₂*) of the plasma simultaneously emit the ultraviolet rays when jumping back to the ground state, and when these ultraviolet rays emitted by the plasma irradiate the fluorescent material, the fluorescent material in the fluorescent material layer 140 emits red, green and blue lights which are then mixed and form the white light thereby.

However, during the process that the discharge gas 150 is ionized into plasma, the fluorescent material layer 140 suffers from ion bombardments. Especially, compared with the red and green fluorescent materials, the blue light fluorescent material used for emitting blue light is apt to suffer from ion bombardments and the blue light intensity decays quickly. Consequently, after long-term usage for the cold cathode fluorescent flat lamp 100 capable of emitting the white light, the Color Chromaticity tends to shift towards red and green colors due to damaged blue light material, and the white light cannot be emitted stably accordingly.

### SUMMARY OF THE INVENTION

In view of this, the object of the present invention is to provide a cold cathode fluorescent flat lamp for lowering the decaying rate of intensity of the blue light.

Based on the above object and others, the present invention provides a cold cathode fluorescent flat lamp comprising a first substrate, a second substrate, multiple of spacers, multiple first electrodes, a blue light fluorescent layer and a discharge gas. The first substrate has a first surface and the second substrate has a second surface. Wherein, the second surface is opposite to the first surface. The spacers are connected with the edges of the first and the second substrates, and a chamber is formed between the first substrate and the second substrate. These first electrodes are disposed on the first surface of the first substrate, the blue light fluorescent layer disposed on the second surface of the second substrate, and the discharge gas disposed inside the chamber.

In the cold cathode fluorescent flat lamp according to a preferred embodiment of the present invention described above, said cold cathode fluorescent flat lamp may further comprise a dielectric layer disposed on the first surface of the first substrate to cover the first electrodes. Also, in one preferred embodiment, said cold cathode fluorescent flat lamp may further comprise a light-mixing fluorescent layer which is disposed between each pair of the first electrode and suitable for emitting a mixing light of red and green lights. Wherein, the thickness of the light-mixing fluorescent layer is between 10 μm and 200 μm, for instance.

According to a preferred embodiment of the present invention, said cold cathode fluorescent flat lamp may further comprise a protection layer disposed on the blue light fluorescent layer. In one preferred embodiment, the material of the protection layer is Magnesia (MgO) or magnesium fluoride (MgF₂), for instance.

In the cold cathode fluorescent flat lamp according to a preferred embodiment of the present invention described above, the discharge gas is xenon (Xe), argon (Ar), helium (He) or deuterium (D₂), for instance.

In the cold cathode fluorescent flat lamp according to a preferred embodiment of the present invention described above, the gap between the first substrate and the second substrate is between 0.5 mm and 8 mm for instance.

In the cold cathode fluorescent flat lamp according to a preferred embodiment of the present invention described above, the thickness of the blue light fluorescent layer is between 2 μm and 15 μm, for instance.

In summary, in the cold cathode fluorescent flat lamp of the present invention, since the blue light fluorescent layer is dispose on the second substrate and the first electrodes disposed on the first substrate, the blue light fluorescent layer suffers from fewer bombardments by the ions produced during the formation of the plasma, and the intensity of blue light emitted by the blue light fluorescent layer decays slowly. By doing so, the decaying rate of the blue light intensity emitted by the blue light fluorescent layer can be lowered.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows the structure of a conventional cold cathode fluorescent flat lamp.

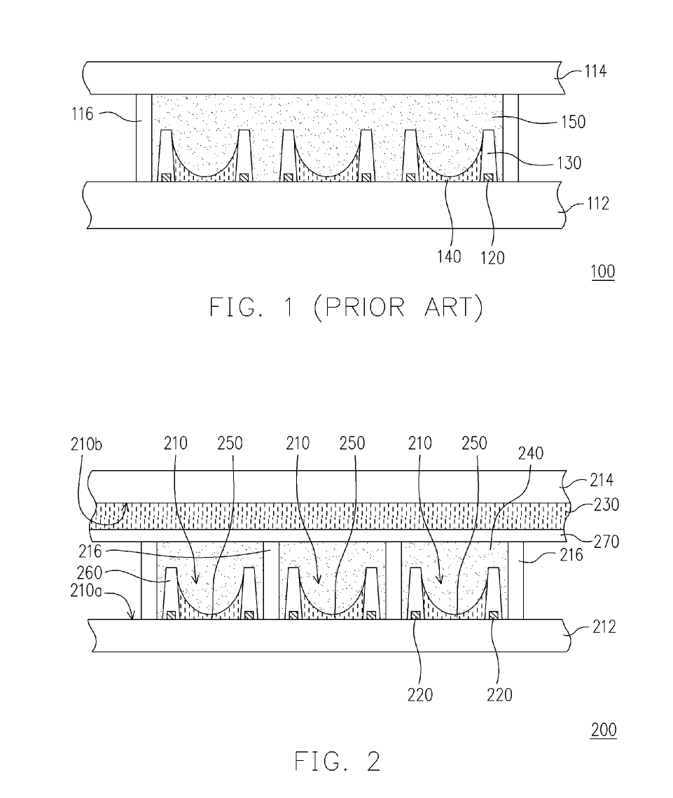

FIG. 2 to FIG. 4 are schematically shows the structure of the cold cathode fluorescent flat lamp according to different embodiment of the present invention, respectively.

FIG. 5 schematically shows the structure of another backlight module employing the cold cathode fluorescent flat lamp of FIG. 2.

### DESCRIPTION OF THE PREFERRED EMBODIMENTS

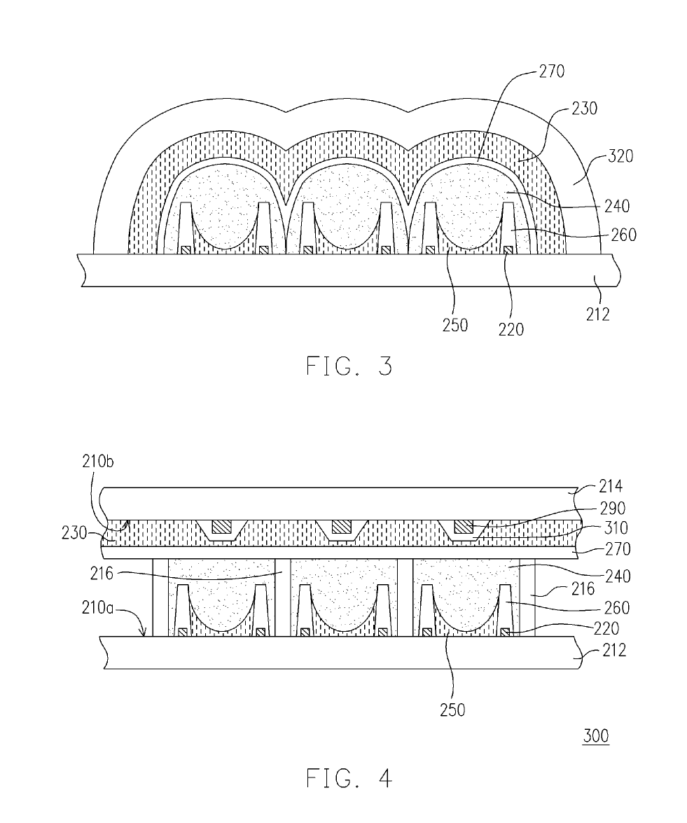

FIG. 2 schematically shows the structure of a cold cathode fluorescent flat lamp according to a preferred embodiment of the present invention. Referring to FIG. 2, the cold cathode fluorescent flat lamp 200 of the present embodiment mainly comprises a first substrate 212, a second substrate 214, multiple spacers 216, multiple first electrodes 220, a blue light fluorescent layer 230, and a discharge gas 240. The first substrate 212 has a first surface 210a and the second substrate 214 disposed above the first substrate 212 has a second surface 210b, and wherein the second surface 210b is opposite to the first surface 210a. Also, the first electrodes 220 are disposed on the first surface 210a, the blue light fluorescent layer 230 disposed on the second surface 210b. The spacer 216 is connected between the first substrate 212 and the second substrate 214 for forming a chamber 210 between the spacer 216, the first substrate 212 and the second substrate 214, and the discharge gas 240 placed inside the chamber 210. It should be noted that in the cold cathode fluorescent flat lamp 200, there are also may a plurality of spacers 216 disposed between the first substrate 212 and the second substrate 214 for keeping the distance therebetween.

Still referring to FIG. 2, the distance between the first surface 210a of the first substrate 212 and the second surface 210b of the second substrate 214 is between 0.5 mm and 8 mm, for example. Particularly, the second substrate may be a non-even substrate in one embodiment of the invention. For example, the second substrate is a lumpy substrate as shown in FIG. 3.

In addition, the thickness of the blue light fluorescent layer 230 disposed on the second surface 210b of the second substrate 214 may be between 2 μm and 10 μm, and the discharge gas 240 is xenon (Xe), argon (Ar), helium (He), deuterium (D₂) or other proper inert gases for instance.

Furthermore, the cold cathode fluorescent flat lamp 200 may further comprises a dielectric layer 260 dispose on the first surface 210a for covering the first electrodes 220, such that the first electrodes 220 and discharge gas 240 are electrically isolated and the bombardments on the first electrodes 220 by the ions produced during the plasma formation of discharge gas 240 can be blocked. In another embodiment of the invention, as shown in FIG. 4, the cold cathode fluorescent flat lamp 300 may further comprises a plurality of second electrodes 290 disposed on the second surface 210b of the second substrate 214, and each second electrode 290 is opposite to the space between the adjacent first electrodes 220. Obviously, each second electrode 290 is covered by a dielectric layer 310, and the second electrode 290 and the dielectric layer 310 are covered by the blue light fluorescent layer 230.

It's worthy to note that, for the purpose of to emitting mixed lights, the cold cathode fluorescent flat lamp 200 may further comprise fluorescent layers capable of emitting lights of other colors. In the present embodiment, the cold cathode fluorescent flat lamp 200 may comprise a light-mixing fluorescent layer 250 disposed on the first surface 210a of the first substrate 212 and located between the first electrodes. Further, the light-mixing fluorescent layer 250 is suitable for emitting a mixing light of red and green lights and its thickness may be between 10 μm and 200 μm.

The cold cathode fluorescent flat lamp 200 is operated by applying a driving voltage on the first electrodes 220 to ionize the discharge gas 240 into plasma state. Following that, the resulting ultraviolet rays excited by the plasma are provided to light the blue light fluorescent layer 230 and light-mixing fluorescent layer 250 such that blue lights emitted by the blue light fluorescent layer 230 and mixing lights of green and red lights emitted by the light-mixing fluorescent layer 250 are mixed together and form the white light accordingly.

During the operating process described above, since the first electrodes 220 are disposed on the first substrate 212, the ions ionized from the discharge gas 240 in the process of forming plasma tend to be closer to the first substrate 212. At this time, the blue light fluorescent layer 230 is disposed on the second substrate 214 and is far away from those ions. Therefore, based on the descriptions above, the blue light fluorescent layer 230 may suffer from fewer ion bombardments compared with the light-mixing fluorescent layer 250, so the intensity of the blue light emitted by the blue light fluorescent layer 230 decays slowly. In this way, after long-term usage the cold cathode fluorescent flat lamp 200 can still stably emit uniform white light and no deviation of the Color Chromaticity occurs.

Additionally, to effectively resist the ion bombardments on the blue light fluorescent layer 230 during the plasma formation of the discharge gas 240, the cold cathode fluorescent flat lamp 200 of the present embodiment can further comprise a protection layer 270 disposed on the blue light fluorescent layer 230. And the material of the protection layer 270 includes Magnesia (MgO) or magnesium fluoride (MgF₂). Because the protection layer 270 can prevent the ion bombardments, formed during the plasma formation of the discharge gas 240, on the blue light fluorescent layer 230. Thus, the decaying rate of the intensity of blue lights emitted by the blue light fluorescent layer 230 can be effectively lowered.

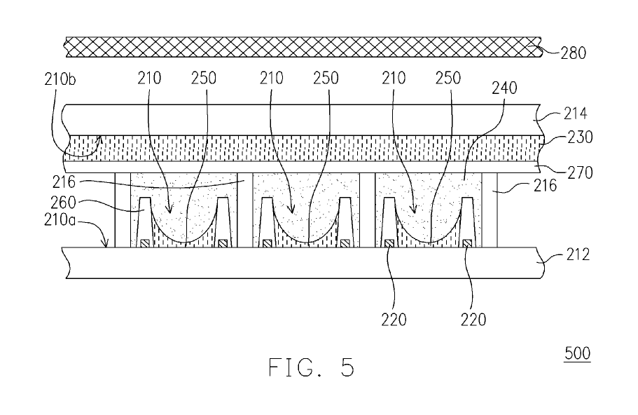

FIG. 5 schematically shows the structure of another backlight module employing the cold cathode fluorescent flat lamp of FIG. 2. It's worthy to note that, referring to FIG. 5, a diffusion plate 280 can be added to the cold cathode fluorescent flat lamp 200 of the present embodiment to form one backlight module 500. This diffusion plate 280 is mounted on the cold cathode fluorescent flat lamp 200 by a mounting frame (not shown) and it's used to assist the backlight module 500 to emit the lights with more uniform brightness. Furthermore, for the above embodiment it's required that a light-mixing distance inside the backlight module 500 for allowing the mixing light of red and green lights emitted by the light-mixing fluorescent layer 250 and the blue lights emitted by the blue light fluorescent layer 230 to be uniformly mixed into the white light, and wherein, this light-mixing distance is the length between the diffusion plate 280 and the cold cathode fluorescent flat lamp 200 and its magnitude depends on the mixing distance actually needed. In the present embodiment, the distance between the diffusion plate 280 and the cold cathode fluorescent flat lamp 200 is between 1 mm and 5 mm, for instance.

To sum up, for the cold cathode fluorescent flat lamp provided by the present invention, since the first electrodes are disposed on the first substrate and the blue light fluorescent layer is dispose on the second substrate, the blue light fluorescent layer can suffer from fewer ion bombardments and the intensity of blue light emitted by the blue light fluorescent layer decays slowly. Thus, the blue light fluorescent layer can stably emit blue lights and life of the cold cathode fluorescent flat lamp is increased thereby.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A cold cathode fluorescent flat lamp, comprising:
a first substrate with a first surface;
a second substrate having a second surface, wherein the second surface is disposed above the first substrate, and the second surface is opposite the first surface of the first substrate;
a plurality of spacers connected with the edges of the first substrate and the second substrate, wherein a chamber is formed between the first substrate and the second substrate;
a plurality of first electrodes disposed on the first surface of the first substrate;
a blue light fluorescent layer disposed on the second surface of the second substrate; and
a discharge gas disposed in the chamber.

2. The cold cathode fluorescent flat lamp according to claim 1, further comprises a first dielectric layer, wherein the first electrodes are covered by the first dielectric layer.

3. The cold cathode fluorescent flat lamp according to claim 2, further comprising a mixing fluorescent layer disposed on the first inner wall and suitable for exciting a mixing light of red light and green light.

4. The cold cathode fluorescent flat lamp according to claim 2, wherein the thickness of the mixing fluorescent layer is between 10 μm and 200 μm.

5. The cold cathode fluorescent flat lamp according to claim 1, further comprising a protection layer disposed on the blue light fluorescent layer.

6. The cold cathode fluorescent flat lamp according to claim 5, wherein the material of the protection layer includes Magnesia (MgO) or magnesium fluoride (MgF₂).

7. The cold cathode fluorescent flat lamp according to claim 1, wherein the discharge gas includes xenon (Xe), argon (Ar), helium (He) or deuterium (D₂).

8. The cold cathode fluorescent flat lamp according to claim 1, wherein a gap between the first substrate and the second substrate is between 0.5 mm and 8 mm.

9. The cold cathode fluorescent flat lamp according to claim 1, wherein the thickness of the blue light fluorescent layer is between 2 μm and 15 μm.

10. The cold cathode fluorescent flat lamp according to claim 1, further comprises a plurality of second electrodes disposed on the second surface of the second substrate.

11. The cold cathode fluorescent flat lamp according to claim 10, further comprises a second dielectric layer covering the second electrodes.
